(19) United States
(12) Patent Application Publication
(10) Pub. No.: US 2010/0007999 A1
(43) Pub. Date: Jan. 14, 2010

(54) STEP-UP SWITCHING REGULATOR

(75) Inventor: Yuki IWATA, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/341,346

(22) Filed: Dec. 22, 2008

(30) Foreign Application Priority Data
Dec. 26, 2007 (JP) JP2007-335313
Dec. 28, 2007 (JP) JP2007-340388

(51) Int. Cl. G05F 1/46; H02H 7/00

(52) U.S. Cl. 361/18; 323/282

(57) ABSTRACT

A first transistor is provided between one terminal of a synchronous rectifying transistor and the back gate thereof, with a body diode of the first transistor being in an orientation such that the cathode thereof corresponds to the output terminal side. A second transistor is provided between the other terminal of the synchronous rectifying transistor and the back gate thereof, with a body diode of the second transistor being in an orientation such that the cathode thereof corresponds to the switching terminal side. During a first period from the boosting stopped state up to the boosting operation state of the switching regulator, a switch control unit instructs the synchronous rectifying transistor to perform a switching operation with the switching transistor set to the OFF state, the first transistor set to the ON state, and the second transistor set to the OFF state.

### BACKGROUND OF THE INVENTION

1. Field of the Invention

The present invention relates to a switching regulator, and particularly to a synchronous rectifying step-up switching regulator.

2. Description of the Related Art

In recent years, various electronic apparatuses such as cellular phone terminals, PDAs (Personal Digital Assistants), laptop personal computers, etc., mount a secondary battery such as a lithium ion battery or the like. The lithium ion battery generates a battery voltage around 3 to 4 V depending upon the state of charge. Such an electronic apparatus mounts electronic devices such as a microprocessor which operates with a power supply voltage of 1.5 V or less, a light-emitting diode which operates with a power supply voltage of around 5 V, etc. In order to respectively supply suitable voltages to such electronic devices, a switching regulator is employed, which boosts or steps down the battery voltage.

The methods employed in the step-up switching regulators and step-down switching regulators include a method employing a rectifying diode (which will be referred to as a “diode rectifying method” hereafter), and a method employing a synchronous rectifying transistor (which will be referred to as a “synchronous rectifying method” hereafter). The former method has the advantage of providing high efficiency when a small load current flows through a load. However, this method requires a diode in the form of a component external to the control circuit, in addition to an inductor and an output capacitor, leading to a large circuit area. The latter method provides small efficiency when a small current is supplied to the load, as compared to the former method. However, with this method, a transistor is employed instead of a diode, and accordingly, the circuit elements can be integrated in an LSI, thereby providing a small circuit area including the peripheral elements. There is a demand for providing small-size electronic apparatuses such as cellular phones. In many cases, such an electronic apparatus employs a switching regulator employing a rectifying switching transistor (which will be referred to as a “synchronous rectifying switching regulator” hereafter).

Here, such a synchronous rectifying step-up switching regulator has a path which connects the synchronous rectifying transistor and the inductor in series between the input terminal via which the battery voltage or the like is input and the output terminal via which the boosted voltage (which will be referred to as the “output voltage” hereafter) is output. In a case in which a P-channel MOSFET is employed as the synchronous rectifying transistor and arranged with the back gate thereof connected to the source (or drain) thereof, such an arrangement has a problem in that, even in a state in which the boosting operation is stopped after the synchronous rectifying transistor has been switched off, a current flows through the load via a body diode (parasitic capacitor) and an inductor between the back gate and the drain (or source).

In order to block the current that flows through the load via the synchronous rectifying transistor and the inductor when the boosting operation is stopped, a method is conceivable in which a DC-blocking transistor is provided on such a current path as a switching element. However, such a DC-blocking transistor serves as a resistor during the boosting operation, leading to a loss of electric power. In order to reduce the loss of electric power due to the DC-blocking transistor, there is a need to design this transistor with a large size so as to reduce the ON-resistance. However, this leads to a problem of an increased circuit area.

The present applicant has proposed a technique for solving the aforementioned problem (Patent document 3).
[Patent Document 1]
   Japanese Patent Application Laid Open No. 2004-32875
[Patent Document 2]
   Japanese Patent Application Laid Open No. 2002-252971
[Patent Document 3]
   Japanese Patent Application Laid Open No. 2007-028784
[Patent Document 4]
   Japanese Patent Application Laid Open No. H10-341141
[Patent Document 5]
   Japanese Patent Application Laid Open No. 2002-010525
[Patent Document 6]
   Japanese Patent Application Laid Open No. 2003-347913

1. Immediately after starting up the switching regulator, in a case in which an ordinary regulation operation is started in which a main switching transistor and a synchronous rectifying transistor are alternately switched ON and OFF, such an arrangement has a problem in that an in-rush current occurs flowing through the output capacitor. In order to gradually raise the output voltage of the switching regulator, there is a need to execute a soft start operation.

During the boosting operation, the output voltage is grater than the input voltage, and accordingly, the current is blocked by the body diode. However, in a case in which the output terminal of the switching regulator is short-circuited (grounded) to the ground terminal, the input terminal is connected to the ground terminal via the inductor, the synchronous rectifying transistor, and the output terminal. In some cases, this leads to a large amount of current flowing from the power supply for the input voltage, resulting in damage to the circuit reliability.

2. In a case in which a P-channel MOSFET is employed as the synchronous rectifying transistor, and the back gate thereof is connected to the source (or drain) thereof, the body diode (parasitic diode) formed between the back gate and the drain (source) and the inductor form a current path which allows the current to flow from the input terminal to the output terminal.

### SUMMARY OF THE INVENTION

An embodiment of the present invention has been made in view of such a situation. Accordingly, it is a purpose of an embodiment of the present invention to provide a switching regulator which is capable of executing a soft start operation, and is capable of preventing current from flowing when the boosting operation is stopped, without a need to provide a DC-blocking transistor.

Another embodiment of the present invention has been made in view of such a situation. Accordingly, it is a purpose of an embodiment of the present invention to provide a synchronous rectifying step-up switching regulator having a ground fault protection function.

1. An embodiment of the present invention relates to a step-up switching regulator employing a synchronous rectifying method. The switching regulator includes: an inductor and a switching transistor provided in series between an input terminal, via which an input voltage is applied, and a fixed-voltage terminal; a synchronous rectifying transistor provided between a switching terminal, which is a connection node that connects the inductor and the switching transistor, and the output terminal; a first transistor provided between one terminal of the synchronous rectifying transistor and the back gate thereof, with a body diode of the first transistor being in an orientation such that the anode thereof corresponds to the switching terminal side; a second transistor provided between the other terminal of the synchronous rectifying transistor and the back gate thereof, with a body diode of the second transistor being in an orientation such that the anode thereof corresponds to the output terminal side; and a switch control unit which controls ON/OFF operations of the switching transistor, the synchronous rectifying transistor, and the first and second transistors. During a first period in which the switching regulator transits from a boosting stopped state to a boosting operation state, the switch control unit instructs the synchronous rectifying transistor to perform a switching operation with the switching transistor set to the OFF state, the first transistor set to the ON state, and the second transistor set to the OFF state.

With such an embodiment, the output capacitor can be charged via the synchronous rectifying transistor which performs a switching operation. Such an embodiment is capable of gradually raising the output voltage until it reaches the input voltage.

Also, the switch control unit may gradually increase the ON duty of the synchronous rectifying transistor during the first period. By adjusting the rate at which the ON duty changes, such an arrangement is capable of controlling the rate at which the output voltage rises.

Also, the switch control unit may set the ON duty of the synchronous rectifying transistor to a fixed value during the first period. Such an arrangement provides a simple circuit configuration.

Also, during a second period before the start of a normal boosting operation after the passage of the first period, the switch control unit may set the switching transistor to the OFF state, may set the first transistor to the OFF state, may set the second transistor to the ON state, and may set the synchronous rectifying transistor to the ON state.

Another embodiment of the present invention also relates to a switching regulator. The switching regulator is a step-up switching regulator employing a synchronous rectifying method, including: an inductor and a switching transistor provided in series between an input terminal, via which an input voltage is applied, and a fixed-voltage terminal; a synchronous rectifying transistor provided between a switching terminal, which is a connection node that connects the inductor and the switching transistor, and the output terminal; a first transistor provided between one terminal of the synchronous rectifying transistor and the back gate thereof, with a body diode of the first transistor being in an orientation such that the cathode thereof corresponds to the output terminal side; a second transistor provided between the other terminal of the synchronous rectifying transistor and the back gate thereof, with a body diode of the second transistor being in an orientation such that the cathode thereof corresponds to the switching terminal side; and a switch control unit which controls ON/OFF operations of the switching transistor, the synchronous rectifying transistor, and the first and second transistors. During a first period in which the switching regulator transits from a boosting stopped state to a boosting operation state, the switch control unit instructs the second transistor to perform a switching operation with the switching transistor set to the OFF state, the synchronous rectifying transistor set to the OFF state, and the first transistor set to the ON state.

With such an embodiment, the output capacitor can be charged via the body diode of the synchronous rectifying transistor and the second transistor which performs a switching operation. Such an embodiment is capable of gradually raising the output voltage until it reaches the input voltage.

Also, the switch control unit may gradually increase the ON duty of the second transistor during the first period. By adjusting the rate at which the ON duty changes, such an arrangement is capable of controlling the rate at which the output voltage rises.

Also, the switch control unit may set the ON duty of the second transistor to a fixed value during the first period. Such an arrangement provides a simple circuit configuration.

Yet another embodiment of the present invention relates to a control circuit for a step-up switching regulator employing a synchronous rectifying method. The control circuit includes: a first terminal to which an input voltage is supplied via an inductor connected to an external circuit; a second terminal connected to an output capacitor; a switching transistor provided between the first terminal and a fixed-voltage terminal; a synchronous rectifying transistor provided between the first terminal and the second terminal; a first transistor provided between the back gate of the synchronous rectifying transistor and the first terminal, with a body diode of the first transistor being in an orientation such that the cathode thereof corresponds to the second terminal side; a second transistor provided between the back gate of the synchronous rectifying transistor and the second terminal, with a body diode of the second transistor being in an orientation such that the cathode thereof corresponds to the first terminal side; and a switch control unit which controls ON/OFF operations of the switching transistor, the synchronous rectifying transistor, and the first and second transistors. During a first period in which the step-up switching regulator transits from a boosting stopped state to a boosting operation state, the switch control unit instructs the synchronous rectifying transistor to perform a switching operation with the switching transistor set to the OFF state, with the first transistor set to the ON state, and with the second transistor set to the OFF state.

Yet another embodiment of the present invention also relates to a control circuit for a step-up switching regulator employing a synchronous rectifying method. The control circuit includes: a first terminal to which an input voltage is supplied via an inductor connected to an external circuit; a second terminal connected to an output capacitor; a switching transistor provided between the first terminal and a fixed-voltage terminal; a synchronous rectifying transistor provided between the first terminal and the second terminal; a first transistor provided between the back gate of the synchronous rectifying transistor and the first terminal, with a body diode of the first transistor being in an orientation such that the cathode thereof corresponds to the second terminal side; a second transistor provided between the back gate of the synchronous rectifying transistor and the second terminal, with a body diode of the second transistor being in an orientation such that the cathode thereof corresponds to the first terminal side; and a switch control unit which controls ON/OFF operations of the switching transistor, the synchronous rectifying transistor, and the first and second transistors. During a first period in which the step-up switching regulator transits from a boosting stopped state to a boosting operation state, the switch control unit instructs the second transistor to perform a switching operation with the switching transistor set to the OFF state, with the synchronous rectifying transistor set to the OFF state, and with the first transistor set to the ON state.

2. An embodiment of the present invention relates to a step-up switching regulator employing a synchronous rectifying method. The switching regulator includes: an inductor and a switching transistor provided in series between an input terminal, via which an input voltage is applied, and a fixed-voltage terminal; an output capacitor connected to the output terminal; a synchronous rectifying transistor provided between a switching terminal, which is a connection node that connects the inductor and the switching transistor, and the output terminal; a first transistor provided between one terminal of the synchronous rectifying transistor and the back gate thereof, with a body diode of the first transistor being in an orientation such that the anode thereof corresponds to the switching terminal side; a second transistor provided between the other terminal of the synchronous rectifying transistor and the back gate thereof, with a body diode of the second transistor being in an orientation such that the anode thereof corresponds to the output terminal side; a switch control unit which controls ON/OFF operations of the switching transistor, the synchronous rectifying transistor, and the first and second transistors; and a ground fault detection circuit which enters the active state after the passage of a predetermined period of time after the start of the boosting operation of the switching regulator, and detects whether or not a ground fault state has occurred, by comparing the output voltage of the switching regulator with a predetermined threshold voltage. In a case in which a ground fault state has been detected, the switch control unit switches at least the synchronous rectifying transistor and the second transistor to the OFF state.

Even in a case in which the switching regulator is not in a ground fault state, the output voltage is low immediately after the start-up operation (immediately after the start of the boosting operation). Accordingly, in a case in which such an output voltage is compared with the threshold voltage, a false judgment is made that a ground fault state has occurred. With such an embodiment, the ground fault detection circuit enters the operation state after the passage of a predetermined period of time after the start of the boosting operation. Thus, such an embodiment prevents such a false judgment from occurring. Each of the synchronous rectifying transistor and the second transistor generates a body diode in an orientation such that the cathode thereof corresponds to the input terminal side. Thus, with such an embodiment, these body diodes prevent a large current from flowing from the input terminal to the ground via the output terminal.

Another embodiment of the present invention also relates to a step-up switching regulator employing a synchronous rectifying method. The switching regulator includes: an inductor and a switching transistor provided in series between an input terminal, via which an input voltage is applied, and a fixed-voltage terminal; an output capacitor connected to the output terminal; a synchronous rectifying transistor provided between a switching terminal, which is a connection node that connects the inductor and the switching transistor, and the output terminal; a DC-blocking transistor provided in series with the synchronous rectifying transistor between the input terminal and the output terminal, with a body diode of the DC-blocking transistor being in an orientation such that the cathode thereof corresponds to the input terminal side; a switch control unit which controls ON/OFF operations of the switching transistor, the synchronous rectifying transistor, and the DC-blocking transistor; and a ground fault detection circuit which enters the active state after the passage of a predetermined period of time after the start of the boosting operation of the switching regulator, and which detects whether or not a ground fault state has occurred, by comparing the output voltage of the switching regulator with a predetermined threshold voltage. In a case in which a ground fault state has been detected, the switch control unit switches at least the synchronous rectifying transistor and the DC-blocking transistor to the OFF state.

Such an arrangement prevents false detection of a ground fault state immediately after the start-up operation. Furthermore, the body diode of the DC-blocking transistor is in an orientation such that the cathode thereof corresponds to the input terminal side, thereby preventing a large current from flowing from the input terminal to the ground via the output terminal.

With such an arrangement, the switching regulator may further include a bias circuit which generates the threshold voltage for the ground fault detection circuit. Also, the bias circuit may be configured such that it can operate even in a state in which the input voltage has dropped due to a ground fault state.

In a case in which the output terminal has entered a ground fault state, the input voltage drops according to the output impedance (current capacity) of the power supply which supplies the input voltage. The ground fault detection circuit must perform a normal operation even in such a ground fault state in which the input voltage has dropped. Such an arrangement allows a ground fault state to be detected in a sure manner.

Also, the switch control unit may be configured such that it is capable of switching the state between the boosting state and the standby state according to an enable signal input from an external circuit. Also, after the passage of a predetermined period of time after the enable signal transits to a level that indicates the boosting state, the ground fault detection circuit may be switched to the active state.

Also, the ground fault detection circuit may be switched to the active state after the passage of a predetermined period of time after the transition to the standby state, in addition to after the passage of a predetermined period of time after the start of the boosting operation. By performing this processing in a case in which the synchronous rectifying transistor has been switched to the ON state in the standby state, such an arrangement allows the ground fault protection to be executed.

Also, the switch control unit may be configured such that it is capable of switching the state between the boosting state and the standby state according to an enable signal input from an external circuit. Also, after the passage of a predetermined period of time after a positive edge or a negative edge has occurred in the enable signal, the ground fault detection circuit may be switched to the active state.

Yet another embodiment of the present invention relates to a control circuit for a step-up switching regulator employing a synchronous rectifying method. The control circuit includes: a first terminal to which an input voltage is supplied via an inductor connected to an external circuit; a second terminal connected to an output capacitor; a switching transistor provided between the first terminal and a fixed-voltage terminal; a synchronous rectifying transistor provided between the first terminal and the second terminal; a first transistor provided between the back gate of the synchronous rectifying transistor and the first terminal, with a body diode of the first transistor being in an orientation such that the anode thereof corresponds to the first terminal side; a second transistor provided between the back gate of the synchronous rectifying transistor and the second terminal, with a body diode of the second transistor being in an orientation such that the anode thereof corresponds to the second terminal side; a switch control unit which controls ON/OFF operations of the switching transistor, the synchronous rectifying transistor, and the first and second transistors; and a ground fault detection circuit which enters the active state after the passage of a predetermined period of time after the start of the boosting operation of the switching regulator, and which detects whether or not the ground fault state has occurred, by comparing the output voltage of the switching regulator with a predetermined threshold voltage. In a case in which a ground fault state has been detected, the switch control unit switches at least the synchronous rectifying transistor and the second transistor to the OFF state.

Yet another embodiment of the present invention also relates to a control circuit for a step-up switching regulator employing a synchronous rectifying method. The control circuit includes: a first terminal to which an input voltage is supplied via an inductor connected to an external circuit; a second terminal connected to an output capacitor; a switching transistor provided between the first terminal and a fixed-voltage terminal; a synchronous rectifying transistor provided between the first terminal and the second terminal; a DC-blocking transistor provided in series with the synchronous rectifying transistor between the first terminal and the second terminal, with a body diode of the DC-blocking transistor being in an orientation such that the anode thereof corresponds to the second terminal side; a switch control unit which controls ON/OFF operations of the switching transistor, the synchronous rectifying transistor, and the DC blocking transistor; and a ground fault detection circuit which enters the active state after the passage of a predetermined period of time after the start of the boosting operation of the switching regulator, and detects whether or not the ground fault state has occurred, by comparing the output voltage of the switching regulator with a predetermined threshold voltage. In a case in which a ground fault state has been detected, the switch control unit switches at least the synchronous rectifying transistor and the DC-blocking transistor to the OFF state.

With such an arrangement, the control circuit may further include a bias circuit which generates the threshold voltage for the ground fault detection circuit. Also, the bias circuit may be configured such that it can operate even in a state in which the input voltage has dropped due to a ground fault state.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows a configuration of a step-up switching regulator according to a first embodiment;

FIG. 2 is a time chart which shows a start-up sequence for the step-up switching regulator shown in FIG. 1;

FIG. 3 is a circuit diagram which shows a configuration of a step-up switching regulator according to a second embodiment;

FIG. 4 is a time chart which shows a start-up sequence for the switching regulator shown in FIG. 3 in a case in which the switching regulator is not in a ground fault state;

FIGS. 5A through 5C are time charts which show a ground fault protection operation of the switching regulator shown in FIG. 3; and

FIGS. 6A and 6B are circuit diagrams which show configurations of switching regulators according to modifications.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B. In the same way, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

In the present specification, the reference numerals that denote electric signals such as voltage signals, current signals, etc., or the reference numerals that denote circuit elements such as resistors, capacitors, etc., also represent the voltage value, the current value, the resistance, or capacitance, as necessary.

### First Embodiment

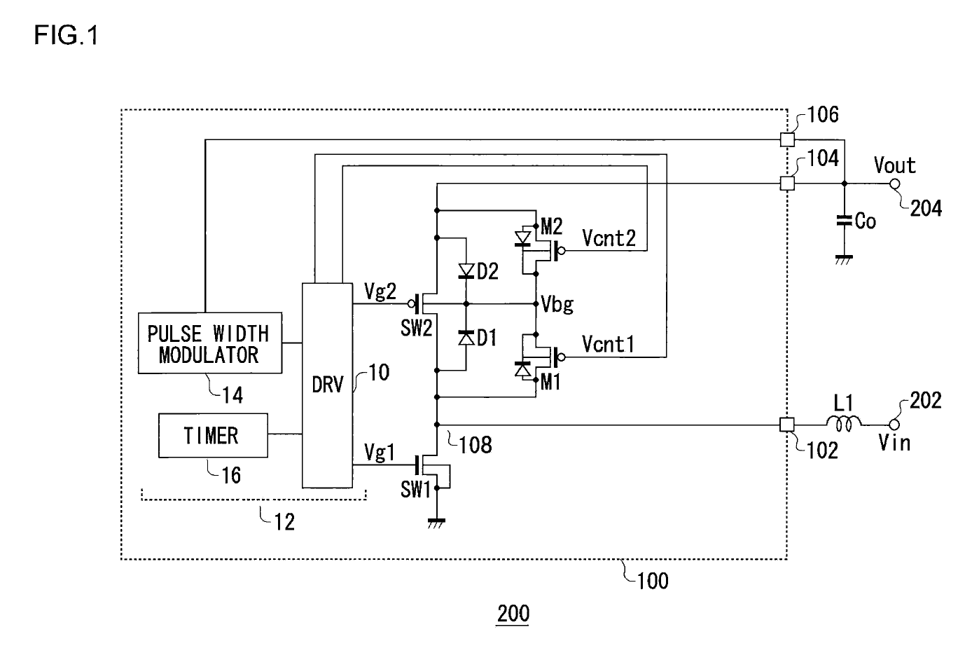

A first embodiment of the present invention relates to a synchronous rectifying step-up switching regulator. FIG. 1 is a circuit diagram which shows a configuration of a step-up switching regulator (which will also be referred to as simply a “switching regulator” hereafter) 200 according to the first embodiment. The switching regulator 200 includes a control circuit 100, an inductor L1, and an output capacitor Co.

The inductor L1 and a switching transistor SW1 are provided in series between an input terminal 202, to which the input voltage Vin is applied, and a fixed-voltage terminal (ground terminal). The switching transistor SW1 is an N-channel MOSFET with the source thereof being grounded and with the drain thereof connected to the inductor L1 via the first terminal 102. The connection node which connects the inductor L1 and the switching transistor SW1 will be referred to as the “switching terminal 108” hereafter.

The output capacitor Co is provided between an output terminal 204 and the ground terminal.

A synchronous rectifying transistor SW2 is a P-channel MOSFET which is provided between the switching terminal 108 and the output terminal 204. One terminal of the synchronous rectifying transistor SW2 is connected to the switching terminal 108, and the other terminal thereof is connected to the output terminal 204.

A first transistor M1 is a P-channel MOSFET which is provided between one terminal of the synchronous rectifying transistor SW2 and the back gate thereof. The body diode of the first transistor M1 is in an orientation such that the cathode thereof corresponds to the output terminal 204 side and the anode thereof corresponds to the switching terminal 108 side.

A second transistor M2 is a P-channel MOSFET which is provided between the other terminal of the synchronous rectifying transistor SW2 and the back gate thereof. The body diode of the second transistor M2 is in an orientation such that the cathode thereof corresponds to the switching terminal 108 side and the anode thereof corresponds to the output terminal 204 side.

The back gates of the first transistor M1 and the second transistor M2 are connected to the back gate of the synchronous rectifying transistor SW2 so as to form a common terminal.

A switch control unit 12 generates a first gate control signal Vg1, a second gate control signal Vg2, a first control signal Vcnt1, and a second control signal Vcnt2, and supplies these control signals thus generated to, respectively, the gates of the switching transistor SW1, the synchronous rectifying transistor SW2, the first transistor M1, and the second transistor M2 so as to control the ON/OFF operations of these transistors.

When the first gate control signal Vg1 is switched to the high-level state, the switching transistor SW1 is switched to the ON state, and when the first gate control signal Vg1 is switched to the low-level state, the switching transistor SW1 is switched to the OFF state. When the second gate control signal Vg2 is switched to the low-level state, the synchronous rectifying transistor SW2 is switched to the ON state, and when the second gate control signal Vg2 is switched to the high-level state, the synchronous rectifying transistor SW2 is switched to the OFF state. When the first control signal Vcnt1 is switched to the low-level state, the first transistor M1 is switched to the ON state, and when the first control signal Vcnt1 is switched to the high-level state, the first transistor M1 is switched to the OFF state. When the second control signal Vcnt2 is switched to the low-level state, the second transistor M2 is switched to the ON state, and when the second control signal Vcnt2 is switched to the high-level state, the second transistor M2 is switched to the OFF state.

The control circuit 100 is a function IC obtained by integrating the switching transistor SW1, the synchronous rectifying transistor SW2, the first transistor M1, the second transistor M2, and the switch control unit 12 on a single semiconductor substrate.

The first terminal 102 is a terminal to be connected to the input terminal 202 via the inductor L1. The input voltage Vin is supplied to the first terminal 102 via the inductor L1. The second terminal 104 is a terminal to be connected to the output terminal 204, and is connected to the output capacitor Co.

The main switching transistor SW1 is arranged with the drain connected to the first terminal 102, and with the source being grounded. Furthermore, the synchronous rectifying transistor SW2 is arranged with the drain connected to the first terminal 102, and with the source connected to the second terminal 104.

The first transistor M1 is provided between the back gate of the synchronous rectifying transistor SW2 and the first terminal 102. The body diode of the first transistor M1 is in an orientation such that the cathode thereof corresponds to the second terminal 104 side and the anode thereof corresponds to the first terminal 102 side.

The second transistor M2 is provided between the back gate of the synchronous rectifying transistor SW2 and the second terminal 104. The body diode of the second transistor M2 is in an orientation such that the cathode thereof corresponds to the first terminal 102 side and the anode thereof corresponds to the second terminal 104 side.

The switch control unit 12 includes a pulse width modulator 14, a driver circuit 10, and a timer 16. The output voltage Vout of the switching regulator 200 is input as a feedback signal to a voltage feedback terminal 106 of the control circuit 100. The output voltage Vout is divided as necessary, and is input to the pulse width modulator 14. The pulse width modulator 14 generates a pulse width modulation signal (which will be referred to as a “PWM signal” hereafter) having a ratio between the high-level period and the low-level period, i.e., a duty ratio, which can be changed. The duty ratio of the PWM signal is controlled such that the output voltage Vout approaches a predetermined reference voltage.

The driver circuit 10 generates the first gate control signal Vg1 and the second gate control signal Vg2 according to the PWM signal output from the pulse width modulator 14, and outputs these gate control signals thus generated to the switching transistor SW1 and the synchronous rectifying transistor SW2, respectively. The switching transistor SW and the synchronous rectifying transistor SW2 alternately perform ON/OFF operations repeatedly, according to the duty ratio of the PWM signal.

The pulse signal can be generated using a known technique such as pulse width modulation (PWM), pulse frequency modulation (PFM), or the like, for example. Also, as a method for providing stable output voltage Vout, available known techniques include: a voltage mode method in which the duty ratio of the pulse signal is changed according to the difference between the output voltage and the target voltage thereof; and a peak current mode method in which the peak value of the current that flows through the inductor L1 is controlled according to the difference between the output voltage and the target value thereof. The configuration of the switch control unit 12 is not restricted in particular.

The switch control unit 12 controls the ON/OFF states of the first transistor M1 and the second transistor M2, in addition to the ON/OFF states of the switching transistor SW1 and the synchronous rectifying transistor SW2.

Specifically, the switch control unit 12 respectively sets the aforementioned transistors to the following states according to the state of the switching regulator 200. The switch control unit 12 includes a function as a state machine which manages each transition between states.

1. Standby State
Switching transistor SW1: OFF
Synchronous rectifying transistor SW2: OFF
First transistor M1: ON
Second transistor M2: OFF

When the boosting operation is stopped, the state is set to the standby state. In the standby state, only the first transistor M1 is set to the ON state so as to prevent the back gate of the synchronous rectifying transistor SW2 from switching to the high impedance state, thereby maintaining the electric potential Vbg at a stable level. In this state, the path that connects the first terminal 102 and the second terminal 104 (the path which connects the input terminal 202 and the output terminal 204) is blocked by a first body diode D1 and a second body diode D2 (and the body diode of the second transistor M2) arranged such that they have opposite orientations.

2. First Start-Up State
Switching transistor SW1: OFF
Synchronous rectifying transistor SW2: Switching operation
First transistor M1: ON
Second transistor M2: OFF

During a first period in time in which the switching regulator is switched from the boosting stopped state to the boosting operation state (boosting state described later), the state is set to the first start-up state. In the first start-up state, the switching transistor SW1 is set to the OFF state, the first transistor M1 is set to the ON state, the second transistor M2 is set to the OFF state, and the synchronous rectifying transistor SW2 is instructed to perform the switching operation.

In this state, the output capacitor Co is charged via the inductor L1 and the synchronous rectifying transistor SW2 which is alternately switched between the ON state and the OFF state, thereby raising the output voltage up to a level approaching the input voltage Vin.

In the first start-up state, the switch control unit 12 may gradually increase the ON duty of the synchronous rectifying transistor SW2. In this case, the rate at which the output voltage Vout rises can be controlled by adjusting the rate at which the ON duty changes. In this case, an arrangement may be made in which a triangular wave (or saw-tooth wave) voltage and a time constant voltage of which the voltage level is changed according to the passage of time are generated, and these two voltages thus generated are compared using a comparator so as to generate the second gate control signal Vg2. Also, the second gate control signal Vg2 may be generated using a digital circuit employing a timer or the like. The method for generating the second gate control signal Vg2 is not restricted in particular.

In the first start-up state, the switch control unit 12 may set the ON duty of the synchronous rectifying transistor SW2 to a fixed value. Such an arrangement provides a simple circuit configuration.

3. Second Start-Up State
Switching transistor SW1: OFF
Synchronous rectifying transistor SW2: ON
First transistor M1: OFF
Second transistor M2: ON

After completion of the first start-up state, the state is set to the second start-up state. In the second start-up state, the synchronous rectifying transistor SW2 is maintained in the ON state. Accordingly, the input terminal 202 and the output terminal 204 are connected to each other via a channel of the synchronous rectifying transistor SW2. Accordingly, the electric potential at the output capacitor Co (i.e., the output voltage Vout) becomes equal to the input voltage Vin.

4. Boosting State
Switching transistor SW1: Switching operation according to a pulse signal
Synchronous rectifying transistor SW2: Switching operation according to a pulse signal
First transistor M1: OFF
Second transistor M2: ON

In the second start-up state, when an instruction is given from an external circuit to start the boosting operation, the state is set to the boosting state. In the boosting state, the first transistor M1 is set to the OFF state, the second transistor M2 is set to the ON state, and the switching transistor SW1 and the synchronous rectifying transistor SW2 perform switching operations such that these transistors are switched to the ON state in a complementary manner. As a result, the output voltage Vout is stably maintained at the target value.

The timer 16 is used to manage each transition between the states. It should be noted that the state may be switched according to an instruction signal from a host processor (not shown) provided as a circuit external to the control circuit 100, instead of providing the timer 16.

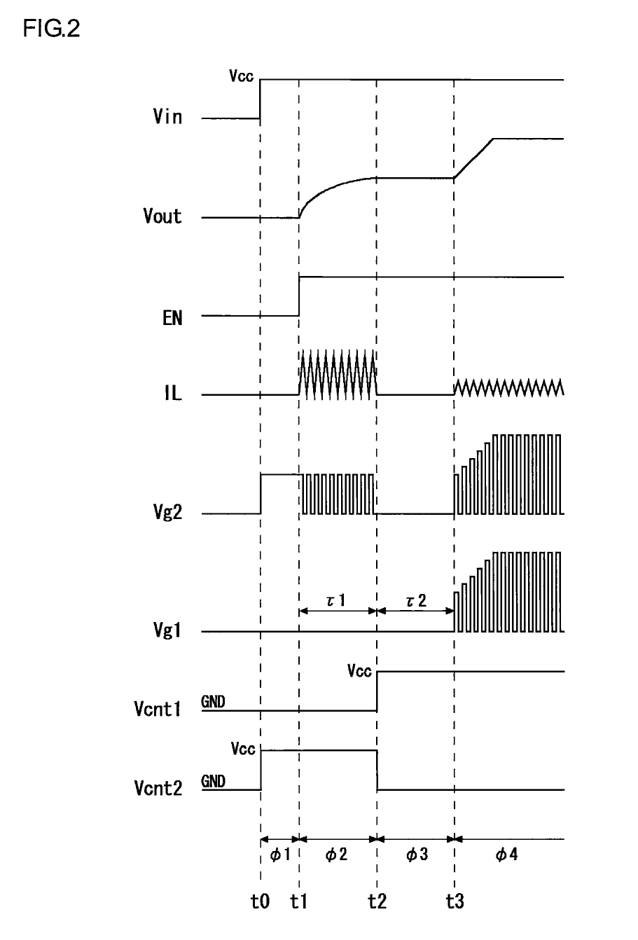

FIG. 2 is a time chart which shows a start-up sequence for the switching regulator 200 shown in FIG. 1.

At the point in time t0, a power supply is turned on for an electronic apparatus mounting the switching regulator 200, and a power supply voltage Vcc is supplied as the input voltage Vin from the battery to the input terminal 202 of the switching regulator 200. After the electric power is supplied, the control circuit 100 which serves as a state machine is switched to the standby state. In the standby state, the path between the switching terminal 108 and the input terminal 202 is DC blocked. Thus, such an arrangement prevents current from flowing through the load, and prevents the output voltage at the output terminal 204 from approaching the input voltage Vin.

After the state has been set to the standby state, at the point in time t1 at which an enable signal EN from the external host processor is switched to the high-level state, the state machine is switched to the first start-up state. After the state machine has been switched to the first start-up state, the second transistor M2 starts the switching operation, and a coil current IL intermittently flows through the inductor L1, thereby charging the output capacitor Co. As a result, the output voltage Vout is raised to a Vcc that equals the input voltage Vin.

The timer 16 counts the first period τ1. At the point in time t2 after the passage of the first period τ1, the state machine is switched to the second start-up state. After the transition to the second start-up state, the synchronous rectifying transistor SW2 is maintained in the ON state, which stably maintains the output voltage Vout at the input voltage Vin. In this state, prior to the subsequent boosting operation, the states of the first transistor M1 and the second transistor M2 are switched.

Subsequently, at the point in time t3 after the passage of the second period 2 from the point in time t2, the state machine is switched to the boosting state. In the boosting state, when the switching transistor SW1 and the synchronous rectifying transistor SW2 perform the switching operations in a complementary manner, the output voltage Vout starts to rise. Subsequently, the output voltage Vout is stably maintained at the target value.

The above-described is the operation of the switching regulator 200. The switching regulator 200 according to the first embodiment is capable of blocking current which flows when the boosting operation is stopped, without a need to provide a DC-blocking transistor. Furthermore, by performing the soft-start operation, such an arrangement is capable of gradually raising the output voltage Vout, thereby preventing in-rush current.

The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding modifications.

The following modification may be made with respect to the above-described first start-up state.

2a. Modification of the First Start-Up State
Switching transistor SW1: OFF
Synchronous rectifying transistor SW2: OFF
First transistor M1: ON
Second transistor M2: Switching operation

That is to say, during the first period τ1, the switch control unit 12 sets the switching transistor SW1 to the OFF state, the synchronous rectifying transistor SW2 is set to the OFF state, the first transistor M1 is set to the ON state, and the second transistor M2 is instructed to perform a switching operation. The ON duty of the second transistor M2 may be set to a fixed value, or may be gradually changed.

In a case in which the first start-up state 2a according to the modification is executed, the second gate control signal Vg2 is maintained at the high level during a period between the points in time t0 and t2. That is to say, the second gate control signal Vg2 exhibits the same waveform as that of the second control signal Vcnt2 shown in the time chart in FIG. 2.

Furthermore, in a case in which the first start-up state 2a according to the modification is executed, the second control signal Vcnt is maintained at the high level during a period between the points in time t0 and t1, and becomes a pulse waveform during a period between the points in time t1 and t2. That is to say, the second control signal Vcnt exhibits the same waveform as that of the second gate control signal Vg2 shown in the time chart in FIG. 2.

Such a modification is also capable of gradually charging the output capacitor Co using the input voltage Vin.

### Second Embodiment

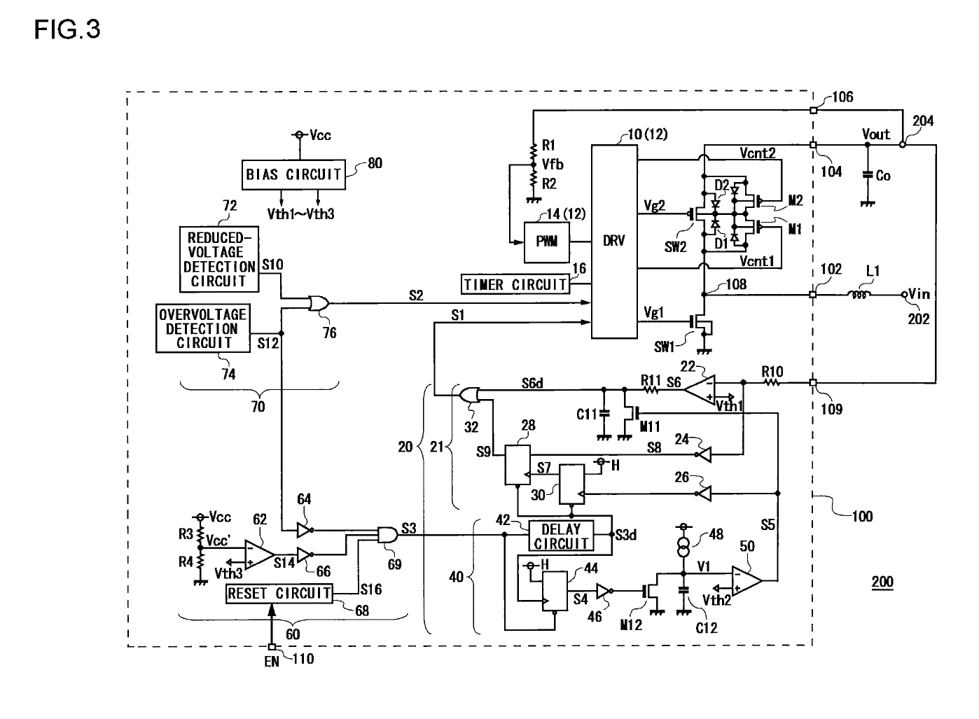

A second embodiment of the present invention also relates to a synchronous rectifying step-up switching regulator. FIG. 3 is a circuit diagram which shows a configuration of a step-up switching regulator (which will also be referred to as simply a “switching regulator” hereafter) 200 according to the second embodiment. In the following description, the content that overlaps with the first embodiment will be omitted as appropriate.

The control circuit 100 is a function IC including a ground fault detection circuit 20, a start-up detection circuit 60, a power supply monitoring circuit 70, and a bias circuit 80, in addition to the switching transistor SW1, the synchronous rectifying transistor SW2, the first transistor M1, and the second transistor M2, which are integrated on a single semiconductor substrate.

The switch control unit 12 controls the ON/OFF operations of the first transistor M1, the second transistor M2, and the switch control unit 12, in addition to the ON/OFF operations of the switching transistor M1 and the synchronous rectifying transistor SW2.

Specifically, the switch control unit 12 sets any one state selected from among the following states according to the state of the switching regulator 200. The same description in the first embodiment can be used for each state.
1. Standby State
2. First start-up state
3. Second start-up state
4. Boosting state

It should be noted that, in the second embodiment, in a case in which a ground fault state described later has been detected during the boosting operation, the state is set to the standby state.

The power supply monitoring circuit 70 monitors the power supply voltage Vcc for the control circuit 100, and judges whether or not the power supply voltage Vcc is within a normal operation range. The power supply voltage Vcc is the input voltage Vin for the switching regulator 200 as a whole, for example. It should be noted that the power supply voltage Vcc may be supplied from another power supply. A under-voltage detection circuit 72 detects a under-voltage state in which the power supply voltage Vcc is smaller than a under-voltage lockout voltage VUVLO. In the under-voltage state, a under-voltage error signal S10 which indicates the detection result is set to the high-level state. An overvoltage detection circuit 74 detects an overvoltage abnormal state in which the power supply voltage Vcc is greater than an overvoltage lockout voltage VOVLO. In the overvoltage state, an overvoltage error signal S12 which indicates the detection result is set to the high-level state. An OR gate 76 calculates the OR of these two signals S10 and S12 which indicate the detection results. The output signal (which will be referred to as the “power supply monitoring signal”) S2 of the OR gate 76 is supplied to the switch control unit 12. When the power supply monitoring signal S2 is switched to the high-level state, the switch control unit 12 is switched to the standby state.

The start-up detection circuit 60 generates a reset signal S3 every time the control circuit 100 (or the switching regulator 200 as a whole) is reset.

The start-up detection circuit 60 includes resistors R3 and R4, a third comparator 62, an inverter 64, a reset circuit 68, and an AND gate 69. The resistors R3 and R4 divide the power supply voltage Vcc. The third comparator 62 compares the power supply voltage Vcc′ thus divided with a predetermined threshold voltage Vth3, and generates a comparison signal S14 which is switched to the high-level state when Vcc′ is smaller than Vth3. The inverter 66 inverts the comparison signal S14. The inverter 64 inverts the under-voltage error signal S12.

The enable signal EN is input from an external host processor to an enable terminal 110 of the control circuit 100. When the enable signal EN is at the low level, the state is set to the standby state. When the enable signal EN is switched to the high-level state, the boosting operation is started, and the state is sequentially switched in order of the first start-up state, the second start-up state, and the boosting state.

The reset circuit 68 generates a reset signal S16 which is switched to the low-level state when the supply of power is started, or every time the level of the enable signal EN is switched, i.e., at each timing at which a positive edge or a negative edge occurs in the enable signal EN.

The AND gate 69 generates the AND of the signals S12, S14, and S16, and outputs the signal thus generated as a reset signal S3. The reset signal S3 is set to the low-level state at a timing at which an overvoltage is detected by the overvoltage detection circuit 74, at a timing at which reduction in the power supply voltage Vcc is detected by the third comparator 62, or at a timing at which the control circuit 100 is reset. The reset signal S3 is input to the ground fault detection circuit 20.

The ground fault detection circuit 20 enters the active state after the passage of a predetermined period of time (which will be referred to as the “mask time Tmsk” hereafter) from the start of the boosting operation of the switching regulator 200. In this state, the ground fault detection circuit 20 compares the output voltage Vout of the switching regulator 200 with a predetermined threshold voltage so as to detect whether or not a ground fault has occurred. The ground fault detection circuit 20 generates a ground fault detection signal S1 which is switched to the high-level state in a case in which a ground fault state has occurred, and outputs the ground fault detection signal S1 thus generated to the switch control unit 12. In a case in which a ground fault state has been detected, the switch control unit 12 switches the state to the standby state in which at least the synchronous rectifying transistor SW2 and the second transistor M2 are switched to the OFF state.

Detailed description will be made regarding a configuration of the ground fault detection circuit 20. The ground fault detection circuit 20 includes a ground fault detection unit 21 and a detection mask circuit 40.

The ground fault detection unit 21 is a circuit which compares the output voltage Vout with a predetermined voltage for detecting a ground fault state. The detection mask circuit 40 sets the mask time Tmsk so as to control, i.e., to enable and disable, the ground fault detection operation of the ground fault detection unit 21.

The detection mask circuit 40 receives the reset signal S3 as an input signal. The detection mask circuit 40 includes a delay circuit 42, a third flip-flop 44, an inverter 46, a constant current source 48, an initializing transistor M12, a time constant capacitor C12, and a second comparator 50.

The delay circuit 42 delays the reset signal S3 by a predetermined delay time. The third flip-flop 44 receives a signal at the high level via its data terminal, the delayed reset signal S3d via its clock terminal, and the reset signal S3 via its reset terminal. The third flip-flop 44 is reset every time the reset signal S3 is switched to the low-level state. Subsequently, at a timing at which the next positive edge occurs in the delayed reset signal S3d, the output signal (mask start signal) S4 of the third flip-flop 44 is set to the high-level state. The output signal S4 of the third flip-flop 44 is switched to the high-level state every time the reset signal S3 is switched to the low-level state.

In other words, in a case in which overvoltage has been detected by the overvoltage detection circuit 74, in a case in which reduction in the power supply voltage Vcc has been detected by the third comparator 62, or in a case in which the control circuit 100 has been reset, after the passage of a delay time, the mask start signal S4 is switched to the high-level state.

The initializing transistor M12, the time constant capacitor C12, the constant current source 48, and the second comparator 50 form a time constant circuit. The constant current source 48 charges the time constant capacitor C12 with one terminal being set to a fixed voltage. The second comparator 50 compares the time constant voltage V1 across the time constant capacitor C12 with a predetermined second threshold voltage Vth2. The second comparator 50 generates a mask signal S5 which is switched to the high-level state when Vth2 is greater than V1. The initializing transistor M12 is provided in parallel with the time constant capacitor C12. The mask start signal S4 inverted by the inverter 46 is input to the gate of the initializing transistor M12.

The initializing transistor M12 is switched to the ON state, and the time constant capacitor C12 is initialized every time the mask start signal S4 is switched to the low-level state. Subsequently, after the mask start signal S4 is switched to the high-level state, the time constant voltage V1 rises with time. During a period from a point in time at which the time constant capacitor C12 is initialized up to a point in time at which the time constant voltage V1 reaches the threshold voltage Vth2, the mask signal S5 is set to the high-level state. After the voltage V1 has reached the threshold voltage Vth2, the mask signal S5 is set to the low-level state. The high-level period of the mask signal S5 corresponds to the mask time Tmsk. The mask signal S5 is supplied to the ground fault detection unit 21.

The ground fault detection unit 21 includes a first comparator 22, resistors R10 and R11, an initializing transistor M11, a time constant capacitor C11, inverters 24 and 26, a first flip-flop 28, a second flip-flop 30, and an OR gate 32.

The output voltage Vout of the switching regulator 200 is input to the voltage monitoring terminal 109. The first comparator 22 compares the output voltage Vout with a threshold voltage (first threshold voltage) Vth1 for detecting a ground fault state. The first comparator 22 generates a first ground fault detection signal S6 which is switched to the high-level state when Vout is smaller than Vth1. The resistor R10 is provided in order to protect the circuit elements included within the control circuit 100 from a surge occurring in the output voltage Vout input to the voltage monitoring terminal 109.

The resistor R11 and the time constant capacitor C11 form a low-pass filter (time constant circuit) having a time constant τ.

In a case in which the first ground fault detection signal S6 has been maintained in the high-level state for the duration of the time constant τ, the first ground fault detection signal S6d input to the OR gate 32 is switched to the high-level state. That is to say, in a case in which the state in which the output voltage Vout is smaller than the threshold voltage Vth3 is maintained for the duration of the time constant τ, the first ground fault detection signal S6d is switched to the high-level state. In a case in which it is desirable that the ground fault protection should be performed immediately after detection of the state in which Vout is smaller than Vth1, the time constant τ should be set to a smaller value. Also, in this case, an arrangement may be made in which the resistor R11 and the time constant capacitor are not provided.

The initializing transistor M11 is provided in parallel with the time constant capacitor C11, and receives the mask signal S5 via the gate as an input signal. The initializing transistor M11 is set to the ON state during the mask time Tmsk in which the mask signal S5 is set to the high-level state. When the initializing transistor M11 is in the ON state, the first ground fault detection signal S6d is fixed to the low-level state, which disables the ground fault state detection operation of the ground fault detection unit 21. Accordingly, after the passage of the mask time Tmsk after the start of the boosting operation, the ground fault detection unit 21 enters the active state and starts detection of whether or not a ground fault state has occurred.

The second flip-flop 30 receives a high level signal as an input signal via its data terminal, and the mask signal S5, which has been inverted by the inverter 26, as an input signal via its clock terminal. The delayed reset signal S3d is input to the reset terminal of the second flip-flop 30. The output signal S7 of the second flip-flop 30 is switched to the high-level state every time the mask signal S5 is switched to the low-level state, i.e., with every passage of the mask time Tmsk.

The inverter 24 inverts the output voltage Vout. When Vout is greater than Vt, the output signal (second ground fault detection signal) S8 of the inverter 24 is set to the low-level state. When Vout is smaller than Vt, the output signal S8 is set to the high-level state. Here, Vt represents the threshold voltage of the inverter. That is to say, the inverter 24 detects a ground fault state using the threshold voltage Vt of the inverter 24 itself.

The second ground fault detection signal S8 is input to the data terminal of the first flip-flop 28, and the output signal S7 of the second flip-flop 30 is input to the clock terminal of the first flip-flop 28. The delayed reset signal S3d is input to the reset terminal of the first flip-flop 28. The output signal S9 of the first flip-flop 28 is set to the value of the second ground fault detection signal S8 with each timing of the passage of the mask time Tmsk.

The OR gate 32 outputs the OR of the signal S6d and the signal S9 as the ground fault detection signal S1. That is to say, the ground fault detection unit 21 provides double detection of a ground fault state using the first comparator 22 and the inverter 24. In a case in which a ground fault state has been detected by either the first comparator 22 or the inverter 24, the ground fault detection unit 21 switches the ground fault detection signal S1 to the high-level state.

In a case in which the ground fault detection signal S1 has been switched to the high-level state, the switch control unit 12 switches the state to the standby state in which the circuit is protected from a ground fault state.

In a case in which the power supply voltage Vcc for the control circuit 100 is the input voltage Vin, the power supply voltage Vcc drops in a ground fault state. The ground fault detection circuit 20 must make voltage comparison with high precision even in such a ground fault state in which the power supply voltage Vcc has dropped. Furthermore, there is a need to set the mask time Tmsk and the time constant τ with high precision. These operations are performed using the threshold voltages Vth1 through Vth3. That is to say, there is a need to generate the stable threshold voltages Vth1 through Vth3 even in such a state in which the power supply voltage Vcc has dropped.

In order to solve such a problem, the bias circuit 80 which generates the threshold voltages Vth1 through Vth3 is configured such that it can operate normally even in a state in which the input voltage Vin has dropped due to a ground fault state. For example, in a case in which the rating input voltage Vin is 5 V, and in a case in which it is predicted that the input voltage Vin will drop down to 2 V in a short-circuit state, the bias circuit 80 should be configured so as to stably generate the threshold voltages Vth1 through Vth3 in a voltage range of 2 to 5 V.

The above-described is the configuration of the switching regulator 200. Next, description will be made regarding the operation of the switching regulator 200.

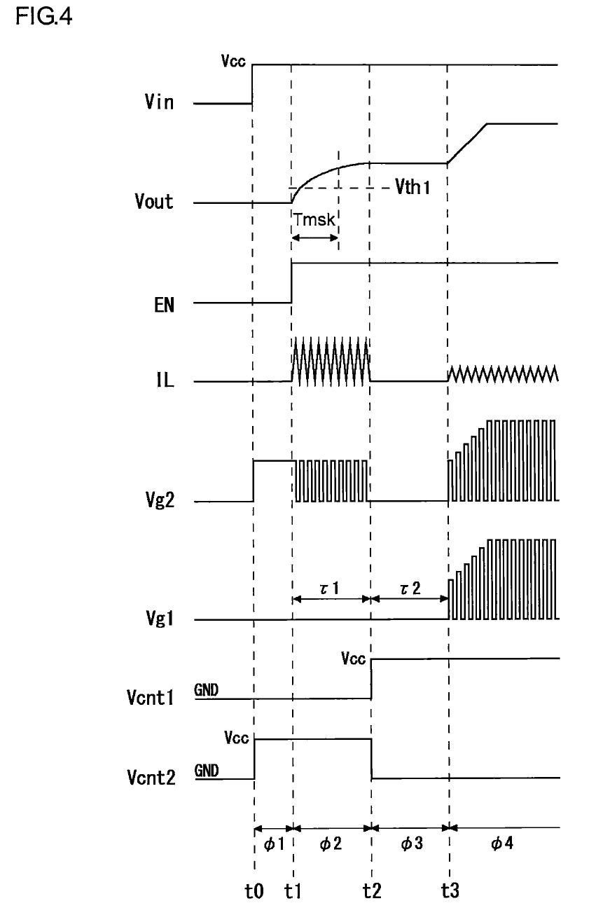

FIG. 4 is a time chart which shows a start-up sequence for the switching regulator 200 shown in FIG. 3 which is not in the ground fault state.

At the point in time t0, a power supply is turned on for an electronic apparatus mounting the switching regulator 200, and a power supply voltage Vcc is supplied as the input voltage Vin from the battery to the input terminal 202 of the switching regulator 200. After the electric power is supplied, the control circuit 100 which serves as a state machine is switched to the standby state. In the standby state, the path between the switching terminal 108 and the input terminal 202 is DC blocked. Thus, such an arrangement prevents current from flowing through the load, and prevents the output voltage at the output terminal 204 from approaching the input voltage Vin.

After the state has been set to the standby state, at the point in time t1 at which an enable signal EN is switched to the high-level state, the state machine is switched to the first start-up state. After the state machine has been switched to the first start-up state, the second transistor M2 starts the switching operation, and a coil current IL intermittently flows through the inductor L1, thereby charging the output capacitor Co. As a result, the output voltage Vout is raised to a Vcc that equals the input voltage Vin.

During the period of the mask time Tmsk after the point in time t1, the detection operation of the ground fault detection circuit 20 is disabled. As a result, even in a case in which Vout has become smaller than Vth1, the ground fault protection is not executed, and the first start-up state is maintained. The timer 16 counts the first period τ1. At the point in time t2 after the passage of the first period τ1, the state machine is switched to the second start-up state. After the transition to the second start-up state, the synchronous rectifying transistor SW2 is maintained in the ON state, which stably maintains the output voltage Vout at the input voltage Vin. In this state, prior to the subsequent boosting operation, the states of the first transistor M1 and the second transistor M2 are switched.

Subsequently, at the point in time t3 after the passage of the second period τ2 from the point in time t2, the state machine is switched to the boosting state. In the boosting state, when the switching transistor SW1 and the synchronous rectifying transistor SW2 perform the switching operations in a complementary manner, the output voltage Vout starts to rise. Subsequently, the output voltage Vout is stably maintained at the target value.

The above-described is the operation of the switching regulator 200 which is not in the ground fault state. The switching regulator 200 according to the second embodiment is capable of blocking current which flows when the boosting operation is stopped, without a need to provide a DC-blocking transistor. Furthermore, by performing the soft-start operation, such an arrangement is capable of gradually raising the output voltage Vout, thereby preventing in-rush current.

Furthermore, during the period of the mask time Tmsk after the start of the boosting operation, the ground fault detection is disabled. Thus, such an arrangement prevents false detection of a ground fault state during a step in which the output voltage Vout is raised.

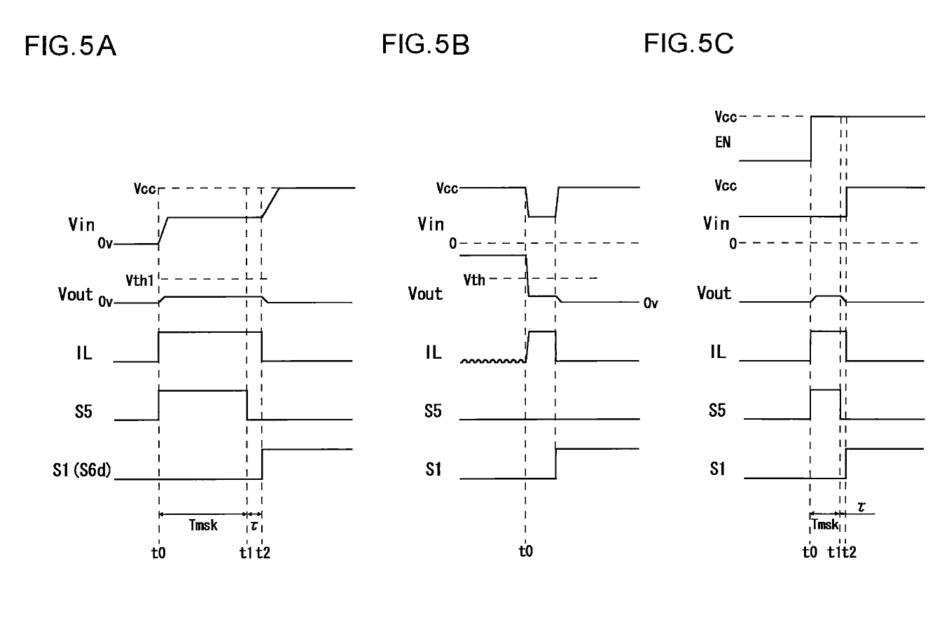

FIGS. 5A through 5C are time charts which show the operation states of the switching regulator 200 shown in FIG. 3. FIG. 5A shows the operation when an instruction is given to start the boosting operation at a timing at which the supply of power is started. FIG. 5B shows the operation in a case in which a ground fault state has occurred in the normal operation. FIG. 5C shows the operation when an instruction is given to start the boosting operation at a timing at which the supply of power is started.

First, referring to FIG. 5A, description will be made regarding the operation when an instruction is given to start the boosting operation at a timing at which the supply of power is started. In the time chart shown in FIG. 5A, a ground fault state has occurred before the point in time t0.

At the point in time t0, the supply of power is started, and the input voltage Vin starts to rise. However, the output terminal 204 is in a ground fault state. Accordingly, the coil current IL flows through the inductor L1 in the overcurrent state. As a result, the input voltage Vin does not rise up to the rated voltage (5V) which is obtained in the normal operation, and is maintained at a low voltage. When the enable signal EN is switched to the high-level state after the supply of power has been started at the point in time t0, an instruction is given to start the boosting operation. As a result, the state sequentially transits from the standby state to the boosting state via the first start-up state and the second start-up state. However, the output terminal 204 is in a ground fault state. Accordingly, the output voltage Vout does not rise, and is maintained at a low voltage around the ground voltage of 0 V.

During the period of the mask time Tmsk after the point in time t0, the ground fault detection unit 21 is set to the non-active state. At the point in time t1 after the passage of the mask time Tmsk, the mask signal S5 is switched to the low-level state, and the ground fault detection unit 21 is switched to the active state. Subsequently, in a case in which a ground fault state (in a state in which Vout is smaller than Vth1) has been maintained for the duration of the time constant τ, at the point in time t2, the ground fault detection signal S1 is switched to the high-level state. In this case, the boosting operation is stopped, and the state is switched to the standby state in which the synchronous rectifying transistor SW2 and the second transistor M2 are set to the OFF state. When the synchronous rectifying transistor SW2 and the second transistor M2 are set to the OFF state, the current path through which current flows from the input terminal 202 to the output terminal 204 is blocked. Accordingly, the coil current IL drops down to 0 A, thereby executing the ground fault protection.

Next, referring to FIG. 5B, description will be made regarding the protection operation in a case in which a ground fault state has occurred in the normal boosting operation. Before the point in time t0, the switching regulator 200 performs a normal boosting operation, and the output voltage Vout is stably maintained at the target value. When the state transits to the normal boosting state via the start-up sequence, the mask signal S5 is set to the low-level state, and accordingly, the initializing transistor M11 is maintained in the OFF state. That is to say, in the normal boosting operation, the mask time Tmsk is not set.

In a case in which a ground fault state has occurred at the point in time t0, the coil current IL is increased, and the output voltage Vout drops down to around the ground voltage of 0 V. The mask time Tmsk is not set. Accordingly, immediately after the output voltage Vout has become smaller than the threshold voltage Vth at the point in time t0, the ground fault detection unit 21 starts detection of whether or not a ground fault state has occurred. In a case in which the first ground fault detection signal S6 has been maintained for the duration of the time constant τ, the ground fault detection signal S1 is set to the high-level state, thereby protecting the circuit from a ground fault state.

FIG. 5C shows the operation when an instruction is given to start the boosting operation at a timing after the supply of power is started. That is to say, FIG. 5C shows the state in which an instruction has been given to start the boosting operation in the standby state in which the input voltage Vin is supplied after the supply of power is started.

While the input voltage Vin is supplied, the output terminal 204 is in a ground fault state. Accordingly, the input voltage Vin is smaller than the power supply voltage Vcc, which should match the input voltage Vin in the normal state. When the enable signal EN is switched to the high-level state at the point in time t0, the boosting operation is started, and the mask signal S5 is switched to the high-level state. At the point in time t1 after the passage of the mask time Tmsk after the point in time t0, the ground fault detection unit 21 enters the active state. In a case in which a ground fault state is maintained for the duration of the time constant τ, the ground fault detection unit 21 outputs the ground fault detection signal S1 at the high level at the point in time t2, thereby protecting the circuit from a ground fault state.

The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding modifications.

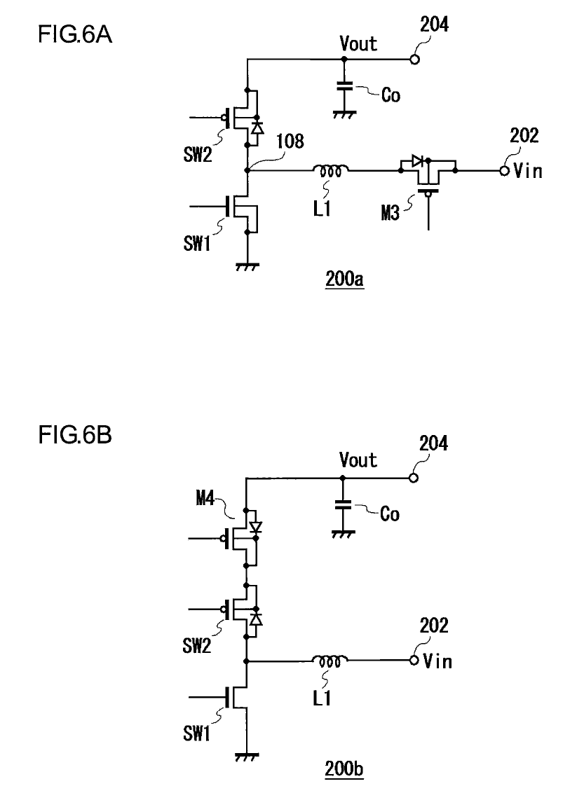

FIGS. 6A and 6B are circuit diagrams which show switching regulators 200a and 200b according to modifications. The switching regulators 200a and 200b shown in FIGS. 6A and 6B include a DC-blocking transistor M3 or M4, instead of the first transistor M1 and the second transistor M2. The other configuration is the same as that shown in FIG. 3, and accordingly, description thereof will be omitted.

The DC-blocking transistor M3 shown in FIG. 6A is provided between the inductor L1 and the input terminal 202. The DC-blocking transistor M4 shown in FIG. 6B is provided between the synchronous rectifying transistor SW2 and the output terminal 204. That is to say, in either case, the DC-blocking transistor M3 shown in FIG. 6A or the DC-blocking transistor M4 shown in FIG. 6B is provided in series with the synchronous rectifying transistor SW2 between the input terminal 202 and the output terminal 204. The body diodes of the DC-blocking transistors M3 and M4 are in an orientation such that the cathodes thereof correspond to the input terminal 202 side. As long as this condition is satisfied, the position relation among the synchronous rectifying transistor SW2, the inductor L1, and the DC-blocking transistor M3 (M4) may be modified as desired.

In a case in which a ground fault state has been detected, an unshown switch control unit (switch control unit 12 shown in FIG. 3) switches the synchronous rectifying transistor SW2 and the DC-blocking transistor M3 (or M4) to the OFF state. The switching regulators 200a and 200b shown in FIGS. 6A and 6B provide protection from a ground fault state in the same way as with the switching regulator 200 shown in FIG. 3.

The following modifications may be made with respect to the aforementioned state.

1a. Standby State
Switching transistor SW1: OFF
Synchronous rectifying transistor SW2: ON
First transistor M1: ON or OFF
Second transistor M2: ON or OFF

With such a modification employing such a standby state, in a case in which a ground fault state has occurred in the standby state, the input terminal 202 is grounded via the synchronous rectifying transistor SW2. Accordingly, such a modification requires a ground fault protection function.

As described above, the reset circuit 68 generates the reset signal S16 which is switched to the low-level state at each timing at which the level of the enable signal EN transits, i.e., at each timing at which a positive edge or a negative edge has occurred in the enable signal EN. Accordingly, at a timing at which the state transits from the boosting state to the standby state (at a timing at which a negative edge occurs in the enable signal EN), the ground fault detection function of the ground fault detection circuit 20 can also be set to the active state. In this case, in order to protect the circuit from a ground fault state, the standby state 1 described above is used, thereby blocking the path between the input terminal 202 and the output terminal 204.

2a. Example Modification of First Start-Up State
Switching transistor SW1: OFF
Synchronous rectifying transistor SW2: OFF
First transistor M1: ON
Second transistor M2: Switching operation

That is to say, during the first period τ1, the switch control unit 12 instructs the second transistor M2 to perform a switching operation with the switching transistor SW1 set to the OFF state, the synchronous rectifying transistor SW2 set to the OFF state, and the first transistor M1 set to the ON state. The ON duty of the second transistor M2 may be fixed or may be changed gradually.

In the case of executing the first start-up state 2a according to the modification, the second gate control signal Vg2 is fixedly set to the high-level state during a period from the points in time t0 to t2. That is to say, the second gate control signal Vg2 exhibits the same waveform as that of the second control signal Vcnt2 shown in the time chart in FIG. 4.

Furthermore, in the case of executing the first start-up state 2a according to the modification, the second control signal Vcnt is fixedly set to the high-level state during a period between the points in time t0 and t1, and exhibits a pulse waveform during a period between the points in time t1 and t2. That is to say, the second control signal Vcnt exhibits the same waveform as that of the second gate control signal Vg2 shown in the time chart in FIG. 4.

Also, such a modification is capable of gradually charging the output capacitor Co with the input voltage Vin.

Description has been made in the first and second embodiments regarding an arrangement in which the control circuit 100 is monolithically integrated in the form of a single LSI. However, the present invention is not restricted to such an arrangement. Also, some portion of the components may be provided as discrete elements or chip elements in the form of components external to the LSI. Also, the control circuit 100 may configured of multiple LSIs.

Also, in the first and second embodiments, the settings of the high level and the low level logical values have been described for exemplary purposes only. The settings may be modified as desired, using an inverter for inverting a signal, etc., as appropriate.

While the preferred embodiments of the present invention have been described using specific terms, such description is for illustrative purposes only, and it is to be understood that changes and variations may be made without departing from the spirit or scope of the appended claims.

What is claimed is:

1. A step-up switching regulator employing a synchronous rectifying method including:
an inductor and a switching transistor provided in series between an input terminal, via which an input voltage is applied, and a fixed-voltage terminal;
an output capacitor connected to the output terminal;
a synchronous rectifying transistor provided between a switching terminal, which is a connection node that connects the inductor and the switching transistor, and the output terminal;
a first transistor provided between one terminal of the synchronous rectifying transistor and the back gate thereof, a body diode of the first transistor being in an orientation such that the anode thereof corresponds to the switching terminal side;
a second transistor provided between the other terminal of the synchronous rectifying transistor and the back gate thereof, a body diode being in an orientation such that the anode thereof corresponds to the output terminal side; and
a switch control unit which controls ON/OFF operations of the switching transistor, the synchronous rectifying transistor, and the first and second transistors,
wherein, during a first period in which the switching regulator transits from a boosting stopped state to a boosting operation state, the switch control unit instructs the synchronous rectifying transistor to perform a switching operation with the switching transistor set to the OFF state, the first transistor set to the ON state, and the second transistor set to the OFF state.

2. A switching regulator according to claim 1, wherein the switch control unit gradually increases the ON duty of the synchronous rectifying transistor during the first period.

3. A switching regulator according to claim 1, wherein the switch control unit sets the ON duty of the synchronous rectifying transistor to a fixed value during the first period.

4. A switching regulator according to claim 1, wherein, during a second period before the start of a normal boosting operation after the passage of the first period, the switch control unit sets the switching transistor to the OFF state, sets the first transistor to the OFF state, sets the second transistor to the ON state, and sets the synchronous rectifying transistor to the ON state.

5. A step-up switching regulator employing a synchronous rectifying method including:
an inductor and a switching transistor provided in series between an input terminal, via which an input voltage is applied, and a fixed-voltage terminal;
an output capacitor connected to the output terminal;
a synchronous rectifying transistor provided between a switching terminal, which is a connection node that connects the inductor and the switching transistor, and the output terminal;
a first transistor provided between one terminal of the synchronous rectifying transistor and the back gate thereof, a body diode of the first transistor being in an orientation such that the anode thereof corresponds to the switching terminal side;
a second transistor provided between the other terminal of the synchronous rectifying transistor and the back gate thereof, a body diode of the second transistor being in an orientation such that the anode thereof corresponds to the output terminal side; and
a switch control unit which controls ON/OFF operations of the switching transistor, the synchronous rectifying transistor, and the first and second transistors,
wherein, during a first period in which the switching regulator transits from a boosting stopped state to a boosting operation state, the switch control unit instructs the second transistor to perform a switching operation with the switching transistor set to the OFF state, the synchronous rectifying transistor set to the OFF state, and the first transistor set to the ON state.

6. A switching regulator according to claim 1, wherein the switch control unit gradually increases the ON duty of the second transistor during the first period.

7. A switching regulator according to claim 1, wherein the switch control unit sets the ON duty of the second transistor to a fixed value during the first period.

8. A control circuit for a step-up switching regulator employing a synchronous rectifying method including:
a first terminal to which an input voltage is supplied via an inductor connected to an external circuit;
a second terminal connected to an output capacitor;
a switching transistor provided between the first terminal and a fixed-voltage terminal;
a synchronous rectifying transistor provided between the first terminal and the second terminal;
a first transistor provided between the back gate of the synchronous rectifying transistor and the first terminal, a body diode of the first transistor being in an orientation such that the anode thereof corresponds to the first terminal side;
a second transistor provided between the back gate of the synchronous rectifying transistor and the second terminal, a body diode of the second transistor being in an orientation such that the anode thereof corresponds to the second terminal side; and
a switch control unit which controls ON/OFF operations of the switching transistor, the synchronous rectifying transistor, and the first and second transistors,
wherein, during a first period in which the switching regulator transits from a boosting stopped state to a boosting operation state, the switch control unit instructs the synchronous rectifying transistor to perform a switching operation with the switching transistor set to the OFF state, with the first transistor set to the ON state, and with the second transistor set to the OFF state.

9. A control circuit for a step-up switching regulator employing a synchronous rectifying method including:
a first terminal to which an input voltage is supplied via an inductor connected to an external circuit;
a second terminal connected to an output capacitor;
a switching transistor provided between the first terminal and a fixed-voltage terminal;
a synchronous rectifying transistor provided between the first terminal and the second terminal;
a first transistor provided between the back gate of the synchronous rectifying transistor and the first terminal, a body diode of the first transistor being in an orientation such that the anode thereof corresponds to the first terminal side;
a second transistor provided between the back gate of the synchronous rectifying transistor and the second terminal, a body diode of the second transistor being in an orientation such that the anode thereof corresponds to the second terminal side; and
a switch control unit which controls ON/OFF operations of the switching transistor, the synchronous rectifying transistor, and the first and second transistors,
wherein, during a first period in which the switching regulator transits from a boosting stopped state to a boosting operation state, the switch control unit instructs the second transistor to perform a switching operation with the switching transistor set to the OFF state, with the synchronous rectifying transistor set to the OFF state, and with the first transistor set to the ON state.

10. A switching regulator employing a synchronous rectifying method including:
an inductor and a switching transistor provided in series between an input terminal, via which an input voltage is applied, and a fixed-voltage terminal;
an output capacitor connected to the output terminal;
a synchronous rectifying transistor provided between a switching terminal, which is a connection node that connects the inductor and the switching transistor, and the output terminal;
a first transistor provided between one terminal of the synchronous rectifying transistor and the back gate thereof, a body diode of the first transistor being in an orientation such that the anode thereof corresponds to the switching terminal side;
a second transistor provided between the other terminal of the synchronous rectifying transistor and the back gate thereof, a body diode of the second transistor being in an orientation such that the anode thereof corresponds to the output terminal side;
a switch control unit which controls ON/OFF operations of the switching transistor, the synchronous rectifying transistor, and the first and second transistors; and
a ground fault detection circuit which enters the active state after the passage of a predetermined period of time after the start of the boosting operation of the switching regulator, and detects whether or not a ground fault state has occurred, by comparing the output voltage of the switching regulator with a predetermined threshold voltage,
wherein, in a case in which a ground fault state has been detected, the switch control unit switches at least the synchronous rectifying transistor and the second transistor to the OFF state.

11. A switching regulator employing a synchronous rectifying method including:
an inductor and a switching transistor provided in series between an input terminal, via which an input voltage is applied, and a fixed-voltage terminal;
an output capacitor connected to the output terminal;
a synchronous rectifying transistor provided between a switching terminal, which is a connection node that connects the inductor and the switching transistor, and the output terminal;
a DC-blocking transistor provided in series with the synchronous rectifying transistor between the input terminal and the output terminal, a body diode of the DC-blocking transistor being in an orientation such that the cathode thereof corresponds to the input terminal side;
a switch control unit which controls the ON/OFF operations of the switching transistor, the synchronous rectifying transistor, and the DC-blocking transistor; and
a ground fault detection circuit which enters the active state after the passage of a predetermined period of time after the start of the boosting operation of the switching regulator, and which detects whether or not a ground fault state has occurred, by comparing the output voltage of the switching regulator with a predetermined threshold voltage,
wherein, in a case in which a ground fault state has been detected, the switch control unit switches at least the synchronous rectifying transistor and the DC-blocking transistor to the OFF state.

12. A switching regulator according to claim 10, further including a bias circuit which generates the threshold voltage for the ground fault detection circuit,
wherein the bias circuit is configured to operate even in a state in which the input voltage has dropped due to a ground fault state.

13. A switching regulator according to claim 11, further including a bias circuit which generates the threshold voltage for the ground fault detection circuit,
wherein the bias circuit is configured to operate even in a state in which the input voltage has dropped due to a ground fault state.

14. A switching regulator according to claim 10, wherein the switch control unit is configured to switch between the boosting state and the standby state according to an enable signal input from an external circuit,
and wherein, after the passage of a predetermined period of time after the enable signal transits to a level that indicates the boosting state, the ground fault detection circuit is switched to the active state.

15. A switching regulator according to claim 11, wherein the switch control unit is configured to switch between the boosting state and the standby state according to an enable signal input from an external circuit,
and wherein, after the passage of a predetermined period of time after the enable signal transits to a level that indicates the boosting state, the ground fault detection circuit is switched to the active state.

16. A switching regulator according to claim 10, wherein the ground fault detection circuit is switched to the active state after the passage of a predetermined period of time after the transition to the standby state, in addition to after the passage of a predetermined period of time after the start of the boosting operation.

17. A switching regulator according to claim 11, wherein the ground fault detection circuit is switched to the active state after the passage of a predetermined period of time after the transition to the standby state, in addition to after the passage of a predetermined period of time after the start of the boosting operation.

18. A switching regulator according to claim 16, wherein the switch control unit is configured to switch between the boosting state and the standby state according to an enable signal input from an external circuit,
and wherein, after the passage of a predetermined period of time after a positive edge or a negative edge has occurred in the enable signal, the ground fault detection circuit is switched to the active state.

19. A switching regulator according to claim 17, wherein the switch control unit is configured to switch between the boosting state and the standby state according to an enable signal input from an external circuit,
and wherein, after the passage of a predetermined period of time after a positive edge or a negative edge has occurred in the enable signal, the ground fault detection circuit is switched to the active state.

20. A control circuit for a synchronous rectifying step-up switching regulator, including:
a first terminal to which an input voltage is supplied via an inductor connected to an external circuit;
a second terminal connected to an output capacitor;
a switching transistor provided between the first terminal and a fixed-voltage terminal;
a synchronous rectifying transistor provided between the first terminal and the second terminal;
a first transistor provided between the back gate of the synchronous rectifying transistor and the first terminal, a body diode of the first transistor being in an orientation such that the anode thereof corresponds to the first terminal side;
a second transistor provided between the back gate of the synchronous rectifying transistor and the second terminal, a body diode of the second transistor being in an orientation such that the anode thereof corresponds to the second terminal side;
a switch control unit which controls ON/OFF operations of the switching transistor, the synchronous rectifying transistor, and the first and second transistors; and
a ground fault detection circuit which enters the active state after the passage of a predetermined period of time after the start of the boosting operation of the switching regulator, and which detects whether or not the ground fault state has occurred, by comparing the output voltage of the switching regulator with a predetermined threshold voltage,
wherein, in a case in which a ground fault state has been detected, the switch control unit switches at least the synchronous rectifying transistor and the second transistor to the OFF state.

21. A control circuit for a synchronous rectifying step-up switching regulator, including:
a first terminal to which an input voltage is supplied via an inductor connected to an external circuit;
a second terminal connected to an output capacitor;
a switching transistor provided between the first terminal and a fixed-voltage terminal;
a synchronous rectifying transistor provided between the first terminal and the second terminal;
a DC-blocking transistor provided in series with the synchronous rectifying transistor between the first terminal and the second terminal, a body diode of the DC-blocking transistor being in an orientation such that the anode thereof corresponds to the second terminal side;
a switch control unit which controls ON/OFF operations of the switching transistor, the synchronous rectifying transistor, and the DC blocking transistor; and
a ground fault detection circuit which enters the active state after the passage of a predetermined period of time after the start of the boosting operation of the switching regulator, and detects whether or not the ground fault state has occurred, by comparing the output voltage of the switching regulator with a predetermined threshold voltage,
wherein, in a case in which a ground fault state has been detected, the switch control unit switches at least the synchronous rectifying transistor and the DC-blocking transistor to the OFF state.

22. A control circuit according to claim 20, further including a bias circuit which generates the threshold voltage for the ground fault detection circuit,
wherein the bias circuit is configured to operate even in a state in which the input voltage has dropped due to a ground fault state.

23. A control circuit according to claim 21, further including a bias circuit which generates the threshold voltage for the ground fault detection circuit,
wherein the bias circuit is configured to operate even in a state in which the input voltage has dropped due to a ground fault state.

24. A control circuit according to claim 20, wherein the switch control unit is configured to switch between the boosting state and the standby state according to an enable signal input from an external circuit,
and wherein, after the passage of a predetermined period of time after the enable signal transits to a level that indicates the boosting state, the ground fault detection circuit is switched to the active state.

25. A control circuit according to claim 21, wherein the switch control unit is configured to switch the state between the boosting state and the standby state according to an enable signal input from an external circuit,
and wherein, after the passage of a predetermined period of time after the enable signal transits to a level that indicates the boosting state, the ground fault detection circuit is switched to the active state.

26. A control circuit according to claim 20, wherein the ground fault detection circuit is switched to the active state after the passage of a predetermined period of time after the transition to the standby state, in addition to after the passage of a predetermined period of time after the start of the boosting operation.

27. A control circuit according to claim 21, wherein the ground fault detection circuit is switched to the active state after the passage of a predetermined period of time after the transition to the standby state, in addition to after the passage of a predetermined period of time after the start of the boosting operation.

28. A control circuit according to claim 26, wherein the switch control unit is configured to switch between the boosting state and the standby state according to an enable signal input from an external circuit,
and wherein, after the passage of a predetermined period of time after a positive edge or a negative edge has occurred in the enable signal, the ground fault detection circuit is switched to the active state.

29. A control circuit according to claim 27, wherein the switch control unit is configured to switch between the boosting state and the standby state according to an enable signal input from an external circuit,
and wherein, after the passage of a predetermined period of time after a positive edge or a negative edge has occurred in the enable signal, the ground fault detection circuit is switched to the active state.
